(19) United States
(12) Patent Application Publication
(10) Pub. No.: US 2017/0129496 A1
(43) Pub. Date: May 11, 2017

(54) METHOD AND VEHICLE TERMINAL THEREOF FOR VEHICLE DATA PROCESSING

(71) Applicant: Leauto Intelligent Technology (BEIJING) Co. Ltd, Beijing (CN)

(72) Inventors: Dan Li, Beijing (CN); Yu Zou, Beijing (CN); Yong Xu, Beijing (CN); Kunsheng Chen, Beijing (CN); Wenrui Li, Beijing (CN); Wei Lin, Beijing (CN); Peng Liu, Beijing (CN)

(21) Appl. No.: 14/975,334

(22) Filed: Dec. 18, 2015

(30) Foreign Application Priority Data
Nov. 6, 2015 (CN) 201510752682.6

(51) Int. Cl. B60W 40/06; B60W 50/14

(52) U.S. Cl. CPC B60W 40/06; B60W 50/14

(57) ABSTRACT

The present disclosure provides a method for vehicle data processing and a vehicle terminal, thereby solving the problem of the prior art that a driving vehicle cannot obtain the road condition ahead in time. The method includes: taking image data of road condition ahead via a camera when it is detected that a current road condition meets a share condition; obtaining current geographic position information as road condition position information via positioning; generating a corresponding driving data share packet by taking the image data of road condition and the road condition position information as road condition data; and sending the driving data share packet to a vehicle temporary network as a broadcast message for sharing the driving data share packet with peripheral devices. The driving data share packet is sent to vehicles in the vehicle temporary network, so that a driving vehicle may obtain the road condition information ahead in time.

### CROSS REFERENCE TO RELATED APPLICATION

The present application claims priority to Chinese Patent Application CN201510752682.6, filed with State Intellectual Property Office on Nov. 6, 2015, which is incorporated herein by reference in its entirety.

### FIELD OF TECHNOLOGY

The present disclosure relates to the field of vehicles, and in particular, to a method for vehicle data processing and a vehicle terminal.

### BACKGROUND

At present, vehicle forward vision systems are mainly used in two aspects: driving recorder and driving prewarning system. Wherein, the driving recorder is used for recording the road condition ahead of a vehicle during vehicle driving so as to record and analyze an accident. The driving prewarning system is represented by Mobileye, which has auxiliary driving prewarning functions such as walker detection and lane offset warning, etc.

The above vehicle forward vision system is based on the visual angle of the current vehicle and serves the current vehicle. However, in fact, when a vehicle drives on a road, the road condition is usually complex due to, for example, sudden traffic accident, invisible ramp and invisible turn, etc., which is a vision blind zone for vehicle drivers, and it is difficult to know the specific road condition unless driving to the corresponding position, and some complex situations cannot be prejudged in advance for a vehicle.

Therefore, at present, it is an urgent technical problem to be solved by one skilled in the art that a vehicle data processing method and a vehicle terminal should be put forward so as to obtain the road condition ahead in time.

### SUMMARY

The embodiments of the present disclosure provide a method for vehicle data processing and a vehicle terminal, thereby solving the problem of the prior art that a driving vehicle cannot obtain the road condition ahead in time.

One embodiment of the present disclosure discloses a method for vehicle data processing, which includes: taking image data of road condition ahead via a camera when it is detected that a current road condition meets a share condition; obtaining current geographic position information as road condition position information via positioning; generating a corresponding driving data share packet by taking the image data of road condition and the road condition position information as road condition data; and sending the driving data share packet to a vehicle temporary network as a broadcast message for sharing the driving data share packet with peripheral devices.

One embodiment of the present disclosure further discloses a vehicle terminal, which includes: a camera, configured for taking image data of road condition ahead via a camera when it is detected that a current road condition meets a share condition; a global positioning system module, configured for obtaining current geographic position information as road condition position information via positioning; a processor, configured for generating a corresponding driving data share packet by taking the image data of road condition and the road condition position information as road condition data; and a Vehicle-to-X (vehicle-to-peripheral device) communication module, configured for sending the driving data share packet to a vehicle temporary network as a broadcast message for sharing the driving data share packet with peripheral devices.

One embodiment of the present disclosure further discloses a device, which includes: a processor; a memory; a program, the program is stored in the memory, and when the program is executed by the processor, following operations are performed: taking image data of road condition ahead via a camera when it is detected that a current road condition meets a share condition; obtaining current geographic position information as road condition position information via positioning; generating a corresponding driving data share packet by taking the image data of road condition and the road condition position information as road condition data; and sending the driving data share packet to a vehicle temporary network as a broadcast message for sharing the driving data share packet with peripheral devices.

In the embodiments of the present disclosure, a picture taken by a camera is received, wherein the picture includes picture data that contain road condition information; according to the picture, a driving data share packet is constructed by the position information to which the picture corresponds, the position information of the current vehicle, the audio data and the picture; the driving data share packet is sent to vehicles in the vehicle temporary network, so that a driving vehicle may obtain the road condition information ahead in time.

### BRIEF DESCRIPTION OF THE DRAWINGS

In order to more clearly illustrate the technical solutions of the embodiments of the present disclosure or of the prior art, the drawings needed in the description of the embodiments or the prior art will be briefly introduced below. Apparently, the drawings in the description below are only some embodiments of the present disclosure, and other drawings may also be obtained by one of ordinary skills in the art according to these drawings without creative work.

FIG. 1 is a structure diagram of a vehicle terminal according to one embodiment of the present disclosure;

FIG. 2 is a flow chart showing the steps of a method for vehicle data processing according to one embodiment of the present disclosure;

FIG. 3 is a structure diagram of a vehicle terminal according to another embodiment of the present disclosure;

FIG. 4 is a flow chart showing the steps of a method for vehicle data processing according to another embodiment of the present disclosure; and

FIG. 5 is a structure diagram of a device according to another embodiment of the present disclosure.

### DESCRIPTION OF THE EMBODIMENTS

In order to make the objects, technical solutions and advantages of the embodiments of the present disclosure more apparent, the technical solutions in the embodiments of the present disclosure will be described clearly and fully below in conjunction with the drawings in the embodiments of the present disclosure. Apparently, the embodiments described are only a part of the embodiments of the present disclosure, rather than being the whole embodiments. All the other embodiments obtained by one of ordinary skills in the art based on the embodiments of the present disclosure without creative work pertain to the protection scope of the present disclosure.

In the prior art, during vehicle driving, the road condition ahead is often predicted via a vehicle forward vision system, and a vehicle that follows cannot obtain the road condition information ahead in time, for example, invisible road condition, so that accurate prediction cannot be realized; as a result, no matter for a front vehicle or a vehicle that follows, the in-time obtaining of the road situation ahead (for example, bumpiness, pit, traffic jam, water log and a large amount of large-scale transport vehicles, etc.) may be favorable for the vehicle that follows to make driving line planning or driving operation (for example, braking and overtaking, etc.) as early as possible. Therefore, the embodiments of the present disclosure provide a method for vehicle data processing and a terminal, a vehicle temporary network is established based on V2X (Vehicle-to-X) communication technology, and by collecting the road condition data during driving and informing the peripheral devices in the vehicle temporary network of the road condition data, a vehicle can know the road condition ahead in time.

### Embodiment 1

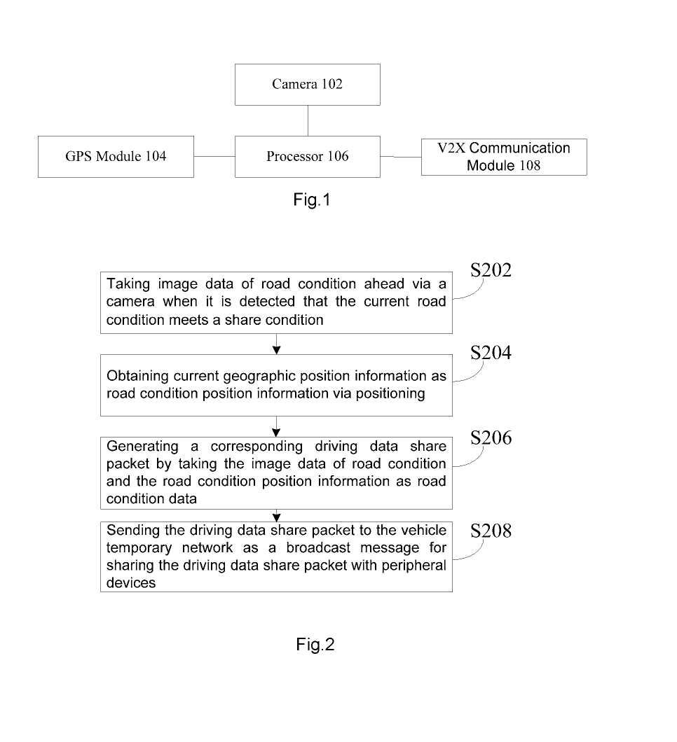

Referring to FIG. 1, it shows a structure diagram of a vehicle terminal according to one embodiment of the present disclosure, which may specifically include the modules below:

a camera 102, a GPS (Global Position System) module 104 and a V2X communication module 108, which are respectively connected with a processor 106.

The camera 102 is configured for taking image data of road condition ahead via a camera when it is detected that a current road condition meets a share condition; the GPS module 104 is configured for obtaining current geographic position information as road condition position information via positioning; the processor 106 is configured for generating a corresponding driving data share packet by taking the image data of road condition and the road condition position information as road condition data; and the V2X communication module 108 is configured for sending the driving data share packet to a vehicle temporary network as a broadcast message for sharing the driving data share packet with peripheral devices.

One embodiment of the present disclosure puts forward a vehicle terminal, and a vehicle driving on a road may perform interaction of road condition ahead based on V2X communication via the vehicle terminal.

Wherein, V2X refers to vehicle-to-peripheral device communication, i.e., vehicle-to-external information exchange, thus X includes vehicle terminal, roadside fixed terminal and server, etc., and V2X realizes communication between vehicle and vehicle, vehicle and base station, and base station and base station. Therefore, a series of traffic information such as real-time road condition, road information and walker information, etc., may be obtained, so that driving security may be improved, traffic jam may be reduced, traffic efficiency may be improved, in-vehicle entertainment information may be provided, and the like. A vehicle temporary network may be established when it communicates based on V2X technology, each terminal may establish wireless communication via a V2X communication module, and the wireless communication technology complies with IEEE802.11P protocol, wherein, all V2X communication modules within a certain distance threshold (for example, 300-1000 m) range can establish a temporary network, and each V2X communication module may perform wireless communication and share a driving data share packet. For example, the transmission distance is designed as 300-1000 m, and the transmission speed is designed as 3M-27 Mbps. V2X is mainly used in the field of intelligent transport and driving active security, thereby traffic accidents may be reduced, and traffic efficiency may be improved. In comparison with 3G/LTE, V2X communication has the advantages that transmission real-time is high, no base station is required, and no operator traffic and charging are required.

During vehicle driving, when the road condition ahead meets a share condition, the camera shoots the road condition ahead, and the camera 102 collects the picture data of the road condition ahead, i.e., takes a picture, and takes the picture data as the road condition data and sends the picture to the processor 106; the processor 106 positions the road section information on the picture by invoking the GPS module according to the picture received, determines the position data of the road condition ahead, and then positions the position of the current vehicle, and obtains the position data of the current vehicle; the processor 106 constructs a driving data share packet by the position data of the road condition ahead, the position data of the current vehicle and the picture, sends the driving data share packet to a V2X communication module; the V2X communication module generates a broadcast message from the driving data share packet received, and sends the driving data share packet to all driving vehicles in the vehicle temporary network in the form of a broadcast message via the V2X communication module, wherein, the broadcast message is used for the information interaction in the vehicle temporary network on which the V2X communication module exists.

Referring to FIG. 2, it is a flow chart showing the steps of a method for vehicle data processing according to one embodiment of the present disclosure, which may specifically include the steps of:

Step S202: taking image data of road condition ahead via a camera when it is detected that a current road condition meets a share condition.

During vehicle driving, when the road condition ahead meets a share condition, the camera shoots the road condition ahead, collects the picture data of the road condition ahead, i.e., takes a picture, receives the picture data, and takes the picture data as the road condition data and sends it to the processor.

Wherein, the preset share condition includes a situation in which the road condition ahead requires the driving vehicle to stop or to slow down. For example, the vehicle detects a barrier ahead such as rockfall, etc., and the volume of the barrier reaches a preset threshold, for example, with a diameter exceeding 30 CM, and it is confirmed that driving of the vehicle is interfered, and at this time, it is determined that the preset share condition is met. In this embodiment, the radar is an electronic device that detects a target via electromagnetic waves. The radar emits electromagnetic waves, irradiates on the target and receives their echo waves, thereby information such as the distance from the target to the electromagnetic wave emission point, the distance change rate (radial speed), the orientation and the height, etc., may be obtained.

Step S204: obtaining current geographic position information as road condition position information via positioning.

After the processor receives the picture taken by the camera, it invokes the GPS module and obtains the road condition position data by positioning the road condition position on the picture, and then positions the position data of the current vehicle; wherein, the road condition position data and the current vehicle position data construct the road condition position information.

Step S206: generating a corresponding driving data share packet by taking the image data of road condition and the road condition position information as road condition data.

The processor constructs, according to the picture received, a driving data share packet by the position data of the road condition ahead, the position data of the current vehicle and the picture, and sends the driving data share packet to a V2X communication module.

In one preferred embodiment of the present disclosure, by recording audio data, which may be used for describing the specific information of the road condition on the picture, audio data may also be added into the driving data share packet for prompting a user via voice.

Step S208: sending the driving data share packet to a vehicle temporary network as a broadcast message for sharing the driving data share packet with peripheral devices.

One embodiment of the present disclosure puts forward a terminal for vehicle data processing, and a vehicle driving on a road may perform interaction of road condition ahead based on V2X communication via the vehicle terminal.

A V2X communication module receives a driving data share packet and converts the driving data packet into a broadcast message, wherein the broadcast message is used for the information interaction in the vehicle temporary network on which the V2X communication module exists, and sends the driving data share packet to peripheral devices in the vehicle temporary network in the form of a broadcast message.

Wherein, the peripheral devices include: all driving vehicles in the same vehicle temporary network, or roadside fixed devices.

In one embodiment of the present disclosure, a picture taken by a camera is received, wherein the picture includes picture data that contain road condition information, and according to the picture, a driving data share packet is constructed by the position information to which the picture corresponds, the position information of the current vehicle and the picture; and the driving data share packet is sent to vehicles in the vehicle temporary network, so that the problem that a driving vehicle cannot obtain the road condition ahead in time may be solved.

### Embodiment 2

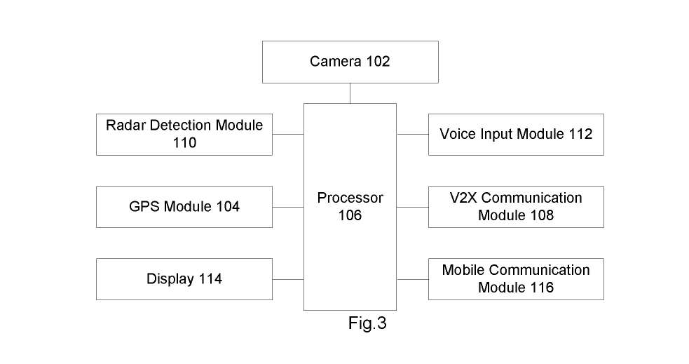

Referring to FIG. 3, it shows a structure diagram of a vehicle terminal according to another embodiment of the present disclosure, which may specifically include the modules below:

a radar detection module 110, a camera 102, a V2X communication module 108, a GPS module 104, a voice input module 112, a display 114 and a mobile communication module 116, which are respectively connected with a processor 106.

Specifically, the radar detection module 110 is configured for monitoring the road condition ahead via a radar, and determining whether the current road condition meets the share condition; the camera 102 is configured for taking the image data of the road condition ahead via a camera when it is detected that the current road condition meets a share condition, and sends the picture to the processor 106; the GPS module 104 is configured for looking up the road condition position information in a map, and marking the road condition position information on the map; the display 114 is configured for displaying the map on which the road condition position information is marked; the processor 106 is further configured for adjusting the driving line information according to the road condition data, so as to obtain the adjusted driving line information; the display 114 is further configured for displaying the adjusted driving line information; the voice input module 112 is configured for recording voice data to generate road condition audio data, and adding the road condition audio data into the road condition data; the processor 106 is configured for taking the road condition image data and the road condition position information as the road condition data, and generating a corresponding driving data share packet; the V2X communication module 108 is configured for sending the driving data share packet to a vehicle temporary network as a broadcast message for sharing the driving data share packet with peripheral devices; the processor 106 is further configured for generating a network data packet from the road condition data; the mobile communication module 116 is configured for uploading the network data packet to a server via a mobile network in order that the server processes the road condition data, and receiving a processing result fed back by the server.

In one preferred embodiment of the present disclosure, a driving vehicle or a roadside fixed device establishes a vehicle temporary network within a certain distance threshold range via a V2X communication module.

One embodiment of the present disclosure puts forward a terminal for vehicle data processing, and a vehicle driving on a road may perform interaction of road condition ahead based on V2X communication via the vehicle terminal.

After a temporary network is established, the driving vehicles in the temporary network may interact with each other, and the radar detection module 110 detects the road condition ahead in real time; when the radar detection module 110 detects that the road condition ahead meets a share condition, and at this time, road condition collection is triggered, and data collection on the road condition ahead is started, wherein, the camera 102 collects the picture data of the road condition ahead, i.e., takes a picture, and takes the picture data as the road condition data, and sends the picture to the processor 106; the processor 106 invokes the GPS module 104, processes the picture data, and takes the position data on the road condition map in the picture as the road condition position data via positioning and marks the position data, and then positions and marks the position data of the current vehicle; the display 114 is configured for displaying the road condition position information and the position information of the current vehicle that are marked; the voice input module 112 inputs audio data via voice to describe the specific information in the picture data, takes the audio data as the road condition audio data, and adds the road condition audio data into the road condition data; the processor 106 generates a driving data share packet from the position data marked on the map to which the picture corresponds, the corresponding position data of the current vehicle marked on the map, the audio data that describes the specific information in the picture data, and the picture, and sends the driving data share packet to the V2X communication module 108; the V2X communication module converts the driving data share packet received into a broadcast message and shares it with peripheral devices in the vehicle temporary network in the form of a broadcast message; the processor 106 is further configured for looking up the current driving line and adjusting the driving line according to the road condition information ahead, for example, rerouting or slowing down, etc.; the display 114 is further configured for display the adjusted driving line; the processor 106 is further configured for generating a network data packet from the road condition data ahead, and sending it to the server via the mobile communication module 116 (for example, a 3G/4G communication module); after the server receives the network data packet, it resolves the network data packet to obtain the road condition information of the driving road section and makes the corresponding feedback, for example, if the road requires manual repair, working personnel will be assigned to salvage the road section, and if rerouting is required due to construction ahead, it will be fed back to the vehicle owner in the form of a message; the mobile communication module 116 receives the feedback message and adjusts the line correspondingly.

For a device embodiment, because it is basically similar to the method embodiment, the description thereof is simple, and for the related part, man can refer to the illustration of the part of the method embodiment.

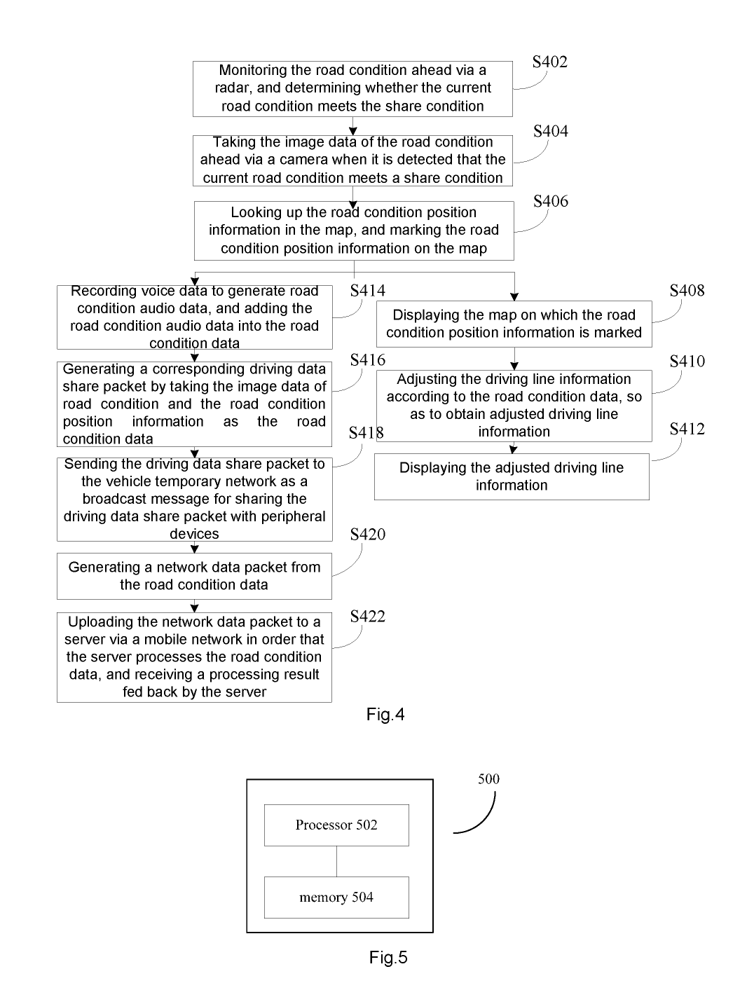

Referring to FIG. 4, it is a flow chart showing the steps of a method for vehicle data processing according to another embodiment of the present disclosure, which may specifically include the steps of:

Step S402: monitoring the road condition ahead via a radar, and determining whether the current road condition meets the share condition.

During vehicle driving, a driving vehicle may establish, by the vehicle terminal, a vehicle temporary network connection within a certain distance threshold range (for example, 300-1000 m) via a V2X communication module, for example, vehicle terminals of driving vehicles or roadside fixed devices within a 300-1000 m range may establish a temporary network via V2X modules.

The radar detection module of the vehicle terminal detects the road condition ahead in real time and determines whether to turn on the camera to shoot and sample the road condition ahead; the turnon of the camera is a condition that meets the share condition, wherein, the preset share condition includes a situation in which the road condition ahead requires the driving vehicle to stop or to slow down. For example, the vehicle detects a barrier ahead such as rockfall, etc., and the volume of the barrier reaches a preset threshold, for example, with a diameter exceeding 30 CM, and it is confirmed that that driving of the vehicle is interfered, and at this time, it is determined that the preset share condition is met.

In this embodiment, the radar is an electronic device that detects a target via electromagnetic waves. The radar emits electromagnetic waves, irradiates on the target and receives their echo waves, thereby information such as the distance from the target to the electromagnetic wave emission point, the distance change rate (radial speed), the orientation and the height, etc., may be obtained.

Step S404: taking the image data of the road condition ahead via a camera when it is detected that the current road condition meets a share condition.

When the radar detection module detects that the road condition ahead meets a share condition, and at this time, data collection is triggered, and data collection on the road condition ahead is started, wherein, the camera collects the picture data of the road condition ahead, i.e., takes a picture, and takes the picture data as the road condition data.

A preferred solution according to one embodiment of the present disclosure includes: when a driver observes that the road condition ahead meets a share condition, the driver may adjust the point of view, take a picture of the road condition ahead that makes the vehicle stop or slow down, and take the picture as the road condition information.

Step S406: looking up the road condition position information in the map, and marking the road condition position information on the map.

Step S408: displaying the map on which the road condition position information is marked.

The processor invokes the GPS module, positions the position to which the road condition in the picture taken by the camera corresponds and displays the position data of the road condition ahead via a display, and then positions the position data of the current vehicle and displays the position information of the current vehicle via a display.

Step S410: adjusting the driving line information according to the road condition data, so as to obtain adjusted driving line information.

Step S412: displaying the adjusted driving line information.

The processor looks up the driving line of the current vehicle, adjusts the driving line information according to the road condition information ahead, for example, rerouting or slowing down, etc., and obtains the adjusted driving line, and displays the adjusted line information via a display.

Step S414: recording voice data to generate road condition audio data, and adding the road condition audio data into the road condition data.

Step S416: generating a corresponding driving data share packet by taking the image data of road condition and the road condition position information as the road condition data.

The processor constructs a road condition driving data share packet by the position information to which the picture corresponds marked on the map, the corresponding position information of the current vehicle marked on the map, the audio data and the picture, and sends the driving data share packet to a V2X communication module.

Step S418: sending the driving data share packet to the vehicle temporary network as a broadcast message for sharing the driving data share packet with peripheral devices.

One embodiment of the present disclosure puts forward a terminal for vehicle data processing, and a vehicle driving on a road may perform interaction of road condition ahead based on V2X communication via the vehicle terminal.

A V2X communication module converts the driving data share packet received into a broadcast message, and the driving data share packet is shared with peripheral devices in the vehicle temporary network in the form of a broadcast message by the V2X communication module.

Wherein, the peripheral devices include driving vehicle terminals or roadside fixed devices in the vehicle temporary network in which the V2X module exists.

Step S420: generating a network data packet from the road condition data.

Step S422: uploading the network data packet to a server via a mobile network in order that the server processes the road condition data, and receiving a processing result fed back by the server.

The processor is further configured for generating a network data packet from the road condition data ahead and sending it to the server via a mobile communication module (for example, a 3G/4G communication module); after the server receives the network data packet, it resolves the network data packet to obtain the road condition information of the driving road section and makes the corresponding feedback, for example, if the road requires manual repair, working personnel will be assigned to salvage the road section, and if rerouting is required due to construction ahead, it will be fed back to the vehicle owner in the form of a message; the mobile communication module receives the feedback message and adjusts the line correspondingly.

In one embodiment of the present disclosure, the road condition ahead is monitored via a radar, and when a share condition is met, the camera starts to collect the road condition information ahead, i.e., takes a picture, and the picture taken by a camera is received, wherein the picture includes picture data that contain road condition information; according to the picture, a driving data share packet is constructed by the position information to which the picture corresponds, the position information of the current vehicle, the audio data and the picture; the driving data share packet is sent to vehicles or roadside fixed devices in the vehicle temporary network, or the road condition information may be sent to a server in the form of a network data packet via a mobile communication module, and the server processes the road condition information correspondingly, so that the problem that a driving vehicle cannot obtain the road condition ahead in time may be solved.

### Embodiment 3

Referring to FIG. 5, it shows a structure diagram of a device 500 according to another embodiment of the present disclosure, which may specifically include: a processor 502; a memory 504; a program is stored in the memory, and when the program is executed by the processor, following operations are performed: taking image data of road condition ahead via a camera when it is detected that a current road condition meets a share condition; obtaining current geographic position information as road condition position information via positioning; generating a corresponding driving data share packet by taking the image data of road condition and the road condition position information as road condition data; and sending the driving data share packet to a vehicle temporary network as a broadcast message for sharing the driving data share packet with peripheral devices.

The operations may further include: monitoring the road condition ahead via a radar, and determining whether the current road condition meets the share condition.

The operations may further include: recording voice data to generate road condition audio data, and adding the road condition audio data into the road condition data.

The operations may further include: looking up the road condition position information in a map, and marking the road condition position information on the map; and displaying the map on which the road condition position information is marked.

The operations may further include: adjusting driving line information according to the road condition data, so as to obtain adjusted driving line information; and displaying the adjusted driving line information.

The operations may further include: generating a network data packet from the road condition data; and uploading the network data packet to a server via a mobile network in order that the server processes the road condition data, and receiving a processing result fed back by the server.

It should be noted that, for a method embodiment, it is expressed as a combination of a series of actions for simple description; however, it should be understood by one skilled in the art that the embodiments of the present disclosure will not be limited to the action order described, because according to the embodiments of the present disclosure, some steps may be performed in other orders or simultaneously. Next, it should also be understood by one skilled in the art that, all the embodiments described in the specification belong to preferred embodiments, and the actions related are not indispensable to the embodiments of the present disclosure.

The device embodiments described above are only illustrative, wherein a module illustrated as a separate part may be or may not be physically separated, and a part illustrated as a module may be or may not be a physical module, that is, it may be located at one place or may be distributed on a plurality of network modules. A part of or all the modules may be selected according to actual demand to implement the object of the embodiment. It will be understood and implemented by one of ordinary skills in the art without creative work.

Each embodiment in this specification is described in a stepped mode, and each embodiment emphasizes a different part from other embodiments, and the same or similar parts among the embodiments may refer to each other.

It should be understood by one skilled in the art that, the embodiments of the present disclosure may be provided as a method, a device or a computer program product. Therefore, the embodiments of the present disclosure may employ the form of complete hardware embodiments, complete software embodiments or a combination of software and hardware embodiments. Moreover, the embodiments of the present disclosure may employ the form of a computer program product that is implemented on one or more computer-usable storage media (including, but not limited to, magnetic disk storage, CD-ROM and optical storage, etc.) containing computer-usable program codes.

The embodiments of the present disclosure are describe referring to the flow chart and/or block diagram of the method, terminal device (system) and computer program product according to the embodiments of the present disclosure. It should be understood that, each flow and/or block in the flow chart and/or block diagram and a combination of a flow and/or a block in the flow chart and/or the block diagram may be implemented by computer program instructions. Such computer program instructions may be provided to a processor of a general-purpose computer, a special-purpose computer, an embedded processor or other programmable data processing terminal devices to generate a machine, so that the instructions executed by the processor of a computer or other programmable data processing terminal devices may generate a device that realizes a function specified in one or more flows of a flow chart and/or in one or more blocks of a block diagram.

These computer program instructions may also be stored on a computer-readable storage that can guide a computer or other programmable data processing terminal devices to work in a specific mode, so that the instructions stored on the computer-readable storage may generate a manufactured article that includes an instruction device, which can realize a function specified in one or more flows of a flow chart and/or in one or more blocks of a block diagram.

These computer program instructions may also be loaded onto a computer or other programmable data processing terminal devices for executing a series of operation steps on the computer or other programmable terminal devices so as to generate computer-implemented processing, thus the instructions executed on a computer or other programmable terminal devices provide a step for realizing the function specified in one or more flows of a flow chart and/or in one or more blocks of a block diagram.

Although some preferred embodiments of the present disclosure have been described, additional variations and modifications may be made to these embodiments by one skilled in the art on learning the basic creative concept. Therefore, the appended claim intends to contemplate the preferred embodiments and all the variations and modifications falling into the range of the embodiments of the present disclosure.

Finally, it should also be noted that, here, the relational terms such as the first and the second, etc., are only used for distinguishing between one entity or operation from another entity or operation, rather than requiring or indicating that any practical relation or sequence exists between these entities or operations. Moreover, terms “include”, “comprise” or any variant thereof intend to encompass non-exclusive “comprise”, so that a process, a method, an article or a terminal device, which includes a series of factors, not only includes such factors, but also includes other factors that are not listed explicitly, or further includes the intrinsic factors of such a process, method, article or terminal device. In the case that no further limitation exists, a factor defined by a sentence “include one . . . ” does not exclude that additional alike factors further exist in the process, method, article or terminal device that includes the factor.

A method for vehicle data processing and a vehicle terminal according to the present disclosure have been introduced in detail above, and the principles and implementation modes of the present disclosure have been illustrated by specific examples, the above embodiments are only used for illustrating the technical solutions of the present disclosure, rather than limiting the scope thereof; although the present disclosure has been illustrated in detail by referring to the above embodiments, it should be understood by one of ordinary skills that, modifications may still be made to the technical solution recorded in each of the above embodiments, or equivalent substitutions may be made to a part of the technical characteristics thereof; moreover, these modifications or substitutions will not make the nature of corresponding technical solution depart from the spirit and scope of the technical solutions of each embodiment of the present disclosure.

What is claimed is:

1. A method for vehicle data processing, comprising:
taking image data of road condition ahead via a camera when it is detected that a current road condition meets a share condition;
obtaining current geographic position information as road condition position information via positioning;
generating a corresponding driving data share packet by taking the image data of road condition and the road condition position information as road condition data; and
sending the driving data share packet to a vehicle temporary network as a broadcast message for sharing the driving data share packet with peripheral devices.

2. The method according to claim 1, the method further comprises:
monitoring the road condition ahead via a radar, and determining whether the current road condition meets the share condition.

3. The method according to claim 2, the method further comprises:
recording voice data to generate road condition audio data, and adding the road condition audio data into the road condition data.

4. The method according to claim 1, the method further comprises:
looking up the road condition position information in a map, and marking the road condition position information on the map; and
displaying the map on which the road condition position information is marked.

5. The method according to claim 1, the method further comprises:
adjusting driving line information according to the road condition data, so as to obtain adjusted driving line information; and
displaying the adjusted driving line information.

6. The method according to claim 1, the method further comprises:
generating a network data packet from the road condition data; and
uploading the network data packet to a server via a mobile network in order that the server processes the road condition data, and receiving a processing result fed back by the server.

7. A vehicle terminal, comprising:
a camera, configured to take image data of road condition ahead via a camera when it is detected that a current road condition meets a share condition;
a global positioning system module, configured to obtain current geographic position information as road condition position information via positioning;
a processor, configured to generate a corresponding driving data share packet by taking the image data of road condition and the road condition position information as road condition data; and
a communication module between vehicle and peripheral devices, configured to send the driving data share packet to a vehicle temporary network as a broadcast message for sharing the driving data share packet with peripheral devices.

8. The vehicle terminal according to claim 7, the vehicle terminal further comprises:
a radar detection module, configured to monitor the road condition ahead via a radar and determining whether the current road condition meets the share condition.

9. The vehicle terminal according to claim 8, the processor further comprises:
a voice input module, configured to record voice data to generate road condition audio data, and adding the road condition audio data into the road condition data.

10. The vehicle terminal according to claim 7, wherein:
the global positioning system module is further configured to look up the road condition position information in a map and marking the road condition position information on the map;
a display is configured to display the map on which the road condition position information is marked.

11. The vehicle terminal according to claim 7, wherein:
the processor is further configured to adjust driving line information according to the road condition data, so as to obtain adjusted driving line information; and
the display is further configured to display the adjusted driving line information.

12. The vehicle terminal according to claim 7, wherein:
the processor is further configured to generate a network data packet from the road condition data; and
a mobile communication module is configured to upload the network data packet to a server via a mobile network in order that the server processes the road condition data, and receiving a processing result fed back by the server.

13. A device, comprising:
a processor;
a memory;
a program, the program is stored in the memory, and when the program is executed by the processor, following operations are performed:
taking image data of road condition ahead via a camera when it is detected that a current road condition meets a share condition;
obtaining current geographic position information as road condition position information via positioning;
generating a corresponding driving data share packet by taking the image data of road condition and the road condition position information as road condition data; and
sending the driving data share packet to a vehicle temporary network as a broadcast message for sharing the driving data share packet with peripheral devices.

14. The device according to claim 13, the operations further comprise:
monitoring the road condition ahead via a radar, and determining whether the current road condition meets the share condition.

15. The device according to claim 14, the operations further comprise:
recording voice data to generate road condition audio data, and adding the road condition audio data into the road condition data.

16. The device according to claim 13, the operations further comprise:
looking up the road condition position information in a map, and marking the road condition position information on the map; and
displaying the map on which the road condition position information is marked.

17. The device according to claim 13, the operations further comprise:
adjusting driving line information according to the road condition data, so as to obtain adjusted driving line information; and
displaying the adjusted driving line information.

18. The device according to claim 13, the operations further comprise:
generating a network data packet from the road condition data; and
uploading the network data packet to a server via a mobile network in order that the server processes the road condition data, and receiving a processing result fed back by the server.
